(19) United States
(12) Patent Application Publication
(10) Pub. No.: US 2021/0110401 A1
(43) Pub. Date: Apr. 15, 2021

(54) Cloud-Based Biometric Payment and Retail Management System, and Payment Method for the Same

(71) Applicant: Ming Tak TSUI, Hong Kong (CN)

(72) Inventor: Ming Tak TSUI, Hong Kong (CN)

(21) Appl. No.: 16/496,436

(22) PCT Filed: Dec. 13, 2018
(86) PCT No.: PCT/CN2018/120793

§ 371 Date: Sep. 22, 2019

(30) Foreign Application Priority Data
Dec. 14, 2017 (HK) 17113362.4
Mar. 12, 2018 (CN) 201820329829.X

(51) Int. Cl. G06Q 20/40; G06Q 20/32; G06Q 20/20

(52) U.S. Cl. CPC G06Q 20/40145; G06Q 20/20; G06Q 20/3278

(57) ABSTRACT

Disclosed are a cloud-based biometric recognition and retail management system and a payment method for the same, wherein the cloud-based biometric recognition and retail management system comprises a POS terminal device, a cloud ERP server, and a cloud payment gateway server; the POS terminal device comprises a front end powered by an Android operating system and a back end powered by a Linux operating system; the front end is connected to the cloud ERP server, and the back end is provided with a password input device and a biometric acquisition and verification device. Its advantageous effects include: by installing an Android OS at the front end and installing a Linux OS at the back end, the dual-system configuration enhances security and compatibility with biometric databases, and wins trust and approval from different institutions, even from the government. A password input device and a biometric acquisition and verification device are disposed at the back end, so as to exploit the biometric recognition technology for secondary verification, such that the biometrics may be directly used as a payment solution without a mobile phone medium; the biometric payment during the payment verification process may prevent crimes and enhance case-solving efficiency.

### CROSS-REFERENCE

The present application claims the priority of Hong Kong short-term patent application No. 17113362.4 entitled “Cloud-Based Biometric Payment and Retail Management System,” filed with the Patents Registry of the Hong Kong Special Administrative Region on Dec. 14, 2017, and the priority of Chinese patent application No. 201820329829.X entitled “Cloud-Based Biometric Payment and Retail Management System,” filed with the Chinese Patent Office on Mar. 12, 2018, the contents of which are fully incorporated herein by reference.

### FIELD

The present disclosure relates to electronic payment, and more particularly relates to a cloud-based biometric payment and retail management system, and payment method for the same.

### BACKGROUND

Following games and entertainments, mobile e-commerce is believed as one of most prosperous businesses for future mobile Internet. Currently, a large number of enterprises swarm into the mobile payment market to seize their shares in the mobile Internet market. Mobile payment security has always been a serious challenge in mobile e-commerce. Among current POS (point-of-sale) terminal devices, more than 70% are powered by Windows operating systems, more than 20% are powered Android operating systems, and less than 10% are powered Linux operating systems. The Linux operating systems demand a high development overhead and only large companies can afford them; this explains why the Linux operating systems are less used.

With rapid development of mobile e-commerce in the smart era, mobile terminals (such as smart phones and tablet computers) have been extensively utilized for payment operations in e-commerce. More and more people go shopping without wallets; they pay directly via mobile phones. However, first, the existing mobile payment manner has a relatively high risk, for example: in the case of payment in a public place, the payment password is easily spied by passers-by. Second, the simple 6-digit password is easily breached. Third, once the payment carrier (mobile phone, computer) is missed, a huge loss will be incurred to the payer. Further, the existing payment manner is monotonic, dampening payment experience of users.

To enhance security, during the process of online payment, a user always receives an SMS (short-messaging service) notification of a verification code to verify the payment, wherein the impermanence property of the verification code guarantees security of the whole payment process. However, the SMS alarm has a big defect, i.e., it is unable to determine whether it is viewed by the user proper. Namely, the bank, after sending the message, has no means to guarantee that the information reaches the user proper; it is also likely that a criminal hijacks the verification code in the user's hand by various means, or the user mistakenly logs on a fishing website and a Trojan virus is implanted into the user's mobile phone, such that the information of the verification code is remotely hijacked. All of the above would undoubtedly affect the user's use experience. Therefore, it becomes an urgent problem to solve as to how to prevent verification information in a terminal from being hijacked and further enhance security of online payment.

Biometric (e.g., fingerprint, facial feature, and iris, etc.) recognition technologies as standard configurations for smart terminals have been widely applied in unlocking and waking-up of smart terminals as well as applied to mobile payment. The biometric payment function may not only overcome the drawback of easy breach of digital passwords, but also offer an advantage of quick and convenient input. However, for a large-amount or a very large-amount transaction, the security of a single verification manner is not enough.

It is a general trend to enhance the security of electronic payment via secondary verification. The current electronic payment relies too heavily on mobile phones; this single verification manner will cause a security issue; besides, the aging population makes it difficult to promote electronic payment via mobile phones. Therefore, the mobile phones are not so useful for the children and the aged during shopping, while the biometric payment is a perfect alternative. No matter how advanced the fingerprint technology and human face recognition technology of mobile phones are, they are useless to financial service companies, because the mobile phone's recognition function cannot get permission from financial institutions. The mobile phones have an assortment of brands and generations. Without a uniform verification standard and uniform hardware, there would be no legal force. Besides, regarding the way of collecting biometrics of a consumer, under the same circumstance, different models of mobile phones cannot serve as equivalent collection mediums. The solution can only be that the financial institution develops its own biometric collection means and approval & verification tool.

In view of the above, it is an objective of the present disclosure to provide a cloud-based biometric payment and retail management system featuring high security, simple operation, and high intelligence.

### SUMMARY

An object of the present disclosure is to provide a cloud-based biometric payment and retail management system and a payment method for the same so as to overcome the drawbacks of the present disclosure.

In a first aspect, there is provided a cloud-based biometric payment and retail management system.

An embodiment of the present disclosure is implemented through the following technical solution:

a cloud-based biometric payment and retail management system, comprising: a cashing service-enabled POS terminal device, a cloud ERP server, and a cloud payment gateway server; wherein the cloud ERP server is connected to the cloud payment gateway server; the POS terminal device comprises a front-end powered by an Android operating system and a back-end powered by a Linux operating system, the front end being connected with the cloud ERP server, the back end being connected to the cloud payment gateway server; and the back end is provided with a password input device and a biometric acquisition and verification device.

Further, the cloud payment gateway server is associated with a server corresponding to a financial institution and a biometric database; after receiving the transaction information transmitted by the POS terminal device, password information inputted by the password input device, and biometric information acquired by the biometric acquisition and verification device, the cloud payment gateway server checks the biometric information with the biometric database, and in the case of consistency, transmits the transaction information and the password information to the server corresponding to the financial institution for approval, such that the server corresponding to the financial institution performs payment transaction and generates transaction data if the approval passes; and the cloud payment gateway server obtains the approval result from the financial institution and the transaction data, and feeds back them to the front end of the POS terminal device.

Further, when receiving the approval result and the transaction data fed back from the cloud payment gateway server, the POS terminal device transmits the transaction data to the cloud ERP server, and the latter updates the product/service information based on the transaction data.

Further, the management system further comprises an electric money box and a power supply module which supplies power to the front end and the back end, wherein the electric money box and the power supply module are electrically connected to the POS terminal device, respectively.

Further, the POS terminal device comprises a network interface, an RAM, a storage space, a control interface, and a microprocessor.

Further, the front end is connected to the cloud ERP server via 4G/TLE modem, Wi-Fi, Bluetooth and/or Ethernet; and the cloud ERP server is connected to a vendor end.

Further, the POS terminal device is connected to a two-dimensional code/three-dimensional code scanner, a front-desk ticket dispenser, a front-desk printer, a labeling machine, a handwriting input panel, and/or an external RAM via a USB controller; and the POS terminal device is connected to a food ordering machine, a wireless two-dimensional code/three-dimensional code scanner, and/or a wireless waiter caller via Bluetooth.

Further, the back end is connected to the cloud payment gateway server via 4G/TLE modem, Wi-Fi, Bluetooth and/or Ethernet.

Further, the POS terminal device comprises a body and a cashier-facing cashier-end contact display, wherein the cashier-end contact display is fixed to the body via a hinge.

Further, the POS terminal device further comprises a high-definition monitor lens, the hinge is provided with a rotary member, and the high-definition monitor lens is mounted to the rotary member.

Further, the biometric acquisition and verification device comprises a customer-facing human face recognition display, a human face recognition high-resolution video camera lens, a high-definition video camera lens for human face recognition or palm print recognition use, a first vocal print recognition receiver, a second vocal print recognition receiver, a far infrared transmitter, a far infrared video camera lens, a fingerprint recognition scanner, and/or a finger vein scanner; the POS terminal device further comprises a customer-facing customer-end contact display which is fixed to the body via a movable hinge; the human face recognition display, the human face recognition high-resolution video camera lens, the high-definition video camera lens for human face recognition or palm print recognition use, the far infrared transmitter, the far infrared video camera lens, the first vocal print recognition receiver, and the second vocal print recognition receiver are provided to the body via the rotary member, and the fingerprint recognition scanner and/or the finger vein scanner are disposed at the top portion of the POS terminal device.

Further, the password input device comprises an NFC (Near Field Communication)/Bluetooth sensor, a two-dimensional code/three-dimensional code scanner, and an NFC/RFID sensor, wherein the NFC/Bluetooth sensor, the two-dimensional code/three-dimensional code scanner, and the NFC/RFID sensor are disposed at the top portion of the POS terminal device.

Further, the POS terminal device further comprises a power switch, a power cord inlet port, an Ethernet cable inlet port, a built-in loudspeaker, and an external USB plug, wherein the built-in loudspeaker is disposed at a side face of the POS terminal device; and the power cord inlet port, the Ethernet cable inlet port, the power switch, and the external USB plug are disposed at the bottom portion of the POS terminal device.

Further, the front-end control interface is connected to the customer-end contact display, the human face recognition high-resolution video camera lens, and the built-in loudspeaker, respectively, to control working states of the customer-end contact display, the human face recognition high-resolution video camera lens, and the built-in loudspeaker.

Further, the back-end control interface is electrically connected to the NFC/RFID sensor, the NFC/Bluetooth sensor, the fingerprint recognition scanner or finger vein scanner, the two-dimensional code/three-dimensional code scanner, the high-definition video camera lens for human face recognition or palm print recognition use, the cashier-end contact display, the movable high-definition monitor lens, the human face recognition display, the first vocal print recognition receiver, the second vocal print recognition receiver, the far infrared transmitter, the far infrared video camera lens, and the built-in loudspeaker, respectively.

A payment method applied to the cloud-based biometric recognition and retail management system comprises:

receiving, by a POS terminal device, product/service information and corresponding quantity inputted by a customer or cashier, obtaining, from a cloud ERP server, price information corresponding to the product/service so as to generate transaction information including a transaction amount based on the price information, product/service information, and corresponding quantity, and transmitting the transaction information to a cloud payment gateway server;

transmitting, by the cloud payment gateway server, an e-wallet input instruction and a biometric input instruction to the POS terminal device based on the transaction information;

receiving, by the POS terminal device, the password information inputted by the customer via the password input device based on the e-wallet input instruction, and the biometric information inputted by the customer via the biometric acquisition and verification device based on the biometric input instruction, and feeding back them to the cloud payment gateway server;

checking, by the cloud payment gateway server, the biometric information with an associated biometric database, and after the verification passes, transmitting the transaction information and the password information to a server corresponding to the financial institution to approve such that the server corresponding to the financial institution performs payment transaction and generates transaction data when the approval result passes; and

obtaining, by the cloud payment gateway server, the approval result of the server corresponding to the financial institution and the transaction data, and feeding back them to the front end of the POS terminal device.

Further, before the cloud payment gateway server obtains the approval result of the server corresponding to the financial institution and the transaction data and feeds back them to the front end of the POS terminal device, the method further comprises:

transmitting, by the POS terminal device, the transaction data to the cloud ERP server; and

updating, by the cloud ERP server, the product/service information based on the transaction data.

Further, before the POS terminal device receives the product/service information and the corresponding quantity inputted by the customer or cashier, the method further comprises:

obtaining, by the POS terminal device, the product/service information from the cloud ERP server.

The present disclosure provides a cloud-based biometric recognition and retail management system and a payment method for the same, wherein the cloud-based biometric recognition and retail management system comprises a POS terminal device, a cloud ERP server, and a cloud payment gateway server; the POS terminal device comprises a front end powered by an Android operating system and a back end powered by a Linux operating system, the front end being connected to the cloud ERP server; and the back end is provided with a password input device and a biometric acquisition and verification device. The present disclosure has an advantageous effect that by leveraging the biometric recognition technology for secondary verification of mobile electronic payment, the biometrics are directly used as a payment solution without a mobile phone medium, such that the biometric payment solution during a payment verification process may prevent crimes and enhance case-solving efficiency.

### Terms

ERP (Enterprise Resource Planning) is a management platform built on information technologies, which integrates the information technologies and the advanced management concepts so as to provide decision means for the employees and the decision-makers of an enterprise with the systematic management idea.

NFC refers to near field communication. RFID refers to radio frequency identification.

The CCTV and security system refers to the closed circuit TV security monitoring system.

Implementation of the present disclosure further includes the following technical effects:

In the cloud-based biometric payment and retail management system disclosed by the present disclosure, the front end is powered by an Android operating system and the back end is powered by a Linux operating system. First, the dual-OS configuration may enhance security. The cloud-based operation may guarantee that customer profiles will not be stored in the POS without presence of an authorized person; use of dual systems enables absolute isolation of the data; the biometric database may use self-developed or updated computer language to prevent hackers without affecting operation of the POS terminal device. Second, the POS terminal device service and the biometric database may be split into two companies which develop and are managed separately. The dual-OS configuration enhances access compatibility. Third, the dual-OS configuration may win trust and approval from different institutions or even the government; besides, an ad playing function is built-in for financial companies, which works 24 hours per day; even the vendor switches off the POS terminal device, the ad display will still work, thereby enhancing the advertising effect. The present disclosure may be integrated with the new-generation ID card functions to serve as a cornerstone for the future Smart City. The cloud-based biometric payment and retail management system according to the present disclosure may serve as a proprietary biometric collection means and approval tools for the financial institution.

In the cloud-based biometric payment and retail management system according to the present disclosure, the back end is provided with both of the password input device and the biometric acquisition and verification device, so as to utilize the biometric recognition technology as secondary verification for mobile electronic payment. It directly becomes a kind of mobile payment, i.e., biometric payment, even without a mobile product such as a mobile phone as a medium. The advantage is that a hacker can hardly steal and splice data from multiple channels. In specific circumstances, a traveler may perform electronic payment even without a mobile phone, a debit card, or a credit card. Secondary verification provides reliability and security for large-sum or very large-sum transactions. The biometric payment solution may prevent crimes and enhance case-solving efficiency.

### BRIEF DESCRIPTION OF THE DRAWINGS

To illustrate the technical solutions of the embodiments of the present disclosure more clearly, the accompanying drawings for the embodiments will be briefly introduced below. It should be understood that the accompanying drawings only illustrate some embodiments of the present disclosure, which should not be regarded as limitations of the scope of the present disclosure. To those skilled in the art, other accompanying drawings may be derived from these drawings without exercise of inventive work.

FIG. 1 is a brief flow schematic diagram of a cloud-based biometric payment and retail management system according to an embodiment of the present disclosure;

FIG. 2 is a brief design schematic diagram of a cloud-based biometric payment and retail management system according to an embodiment of the present disclosure;

FIG. 3 is a detailed design schematic diagram of modules of a cloud-based biometric payment and retail management system according to an embodiment of the present disclosure;

FIG. 4 is a flow schematic diagram of operating a cloud-based biometric payment and retail management system according to an embodiment of the present disclosure;

FIG. 5 is a stereoscopic structural schematic diagram of a POS terminal device according to an embodiment of the present disclosure;

FIG. 6 is another stereoscopic structural schematic diagram of a POS terminal device according to an embodiment of the present disclosure;

FIG. 7 is a side stereoscopic structural schematic diagram of a POS terminal device according to an embodiment of the present disclosure;

FIG. 8 is a stereoscopic structural schematic diagram of a POS terminal device from another perspective according to an embodiment of the present disclosure;

FIG. 9 is a connection block diagram of a cloud-based biometric payment and retail management system according to an embodiment of the present disclosure;

FIG. 10 is a flow schematic diagram of a payment method according to an embodiment of the present disclosure.

1—human face recognition display; 2—human face recognition high-resolution video camera lens; 3—high-definition video camera lens for human face recognition or palm print recognition use; 4—first vocal print recognition receiver; 5—second vocal print recognition receiver; 6—finger print recognition scanner or finger vein scanner; 7—NFC/Bluetooth sensor; 8—two-dimensional code/three-dimensional code scanner; 9—NFC/RFID sensor; 10—customer-end contact display; 11—power switch; 12—movable hinge; 13—built-in loudspeaker; 14—external USB plug; 15—cashier-end contact display; 16—movable high-definition monitor lens; 17—far infrared transmitter; 18—far infrared video camera lens; 19—power cord inlet port; 20—Ethernet cable inlet port; 100—POS terminal device; 200—cloud ERP server; 300—cloud payment gateway server.

### DETAILED DESCRIPTION OF EMBODIMENTS

To make the objects, technical solutions, and advantages of the embodiments of the present disclosure much clearer, the technical solutions in the embodiments of the present disclosure will be described clearly and comprehensively with reference to the accompanying drawings of the embodiments of the present disclosure; apparently, the embodiments as described are only part of the embodiments of the present disclosure, rather than all of them. Generally, the components of the embodiments of the present disclosure as described and illustrated in the drawings may be arranged and designed with various configurations.

Therefore, the detailed depictions of the embodiments of the present disclosure are not intended to limit the scope of the present disclosure, but only to illustrate the preferred embodiments of the present disclosure. All other embodiments obtained by those skilled in the art without exercise of inventive work based on the embodiments in the present disclosure shall fall within the protection scope of the present disclosure.

It should be noted that like reference numerals and letters express similar terms in the accompanying drawings; therefore, once an item is defined in a figure, it needs no further definition and explanation in subsequent drawings.

It needs to be noted that in the depictions of the embodiments of the present disclosure below, the terms “first” and “second” are only used for discriminative purposes, which shall not be understood as indicating or implying a relative importance.

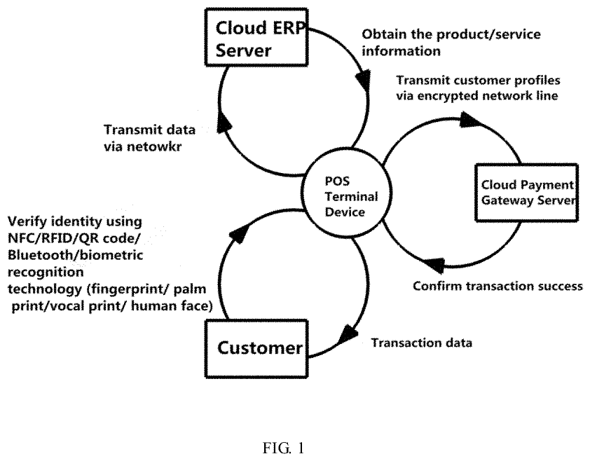

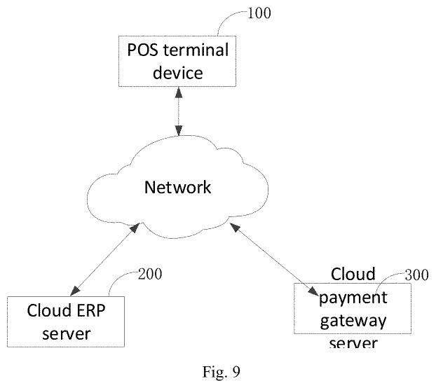

As shown in FIGS. 1 and 9, the brief operating flow of the cloud-based biometric payment and vendor management system is such that: the POS terminal device 100 obtains product/service information from the cloud ERP server 200; the customer obtains transaction data from the POS terminal device; after the transaction is confirmed, identity is verified using the NFC/RFID/QR code/Bluetooth/biometric recognition technology (fingerprint/palm print/vocal print/human face); the POS terminal device 100 transmits, via an encrypted network line, the customer profile to the cloud payment gateway server 300 and submits an electronic transaction application; after the transaction is confirmed successful, it is fed back to the POS terminal device 100; the POS terminal device 100 transmits, via the network, transaction data to the cloud ERP server 200 and prints receipts; then the transaction is completed.

The cloud-based biometric payment and retail management system according to the embodiment comprises: a cashing service-enabled POS terminal device 100, a cloud-based ERP server 200, and a cloud payment gateway server 300, wherein the cloud ERP server 200 is connected to the cloud payment gateway server 300; the POS terminal device comprises a front-end powered by an Android operating system and a back-end powered by a Linux operating system, the front end being connected with the cloud ERP server 200, the back end being connected to the cloud payment gateway server 300; and the back end is provided with a password input device and a biometric acquisition and verification device.

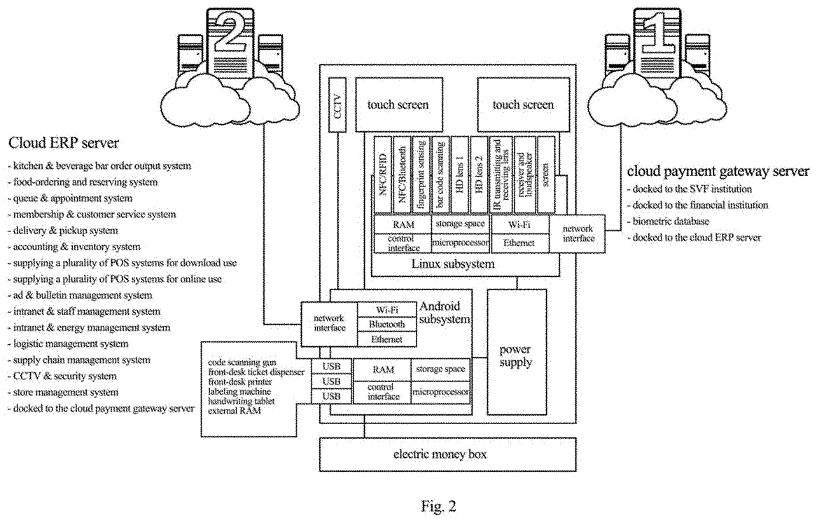

Specifically referring to FIG. 2, in this embodiment, the front end of the POS terminal device 100 refers to the end facing the customer/consumer and equipped with a front-mounted touch screen; the rear end refers to the end facing the server of the financial institution/the biometric database and configured to perform cashing operations, which is also configured with a back-mount touch screen. The back end is powered by a Linux system, hardware of which is configured for managing and connecting the customer-facing touch screen and all recognition input devices (including NFC, RFID, QR code, fingerprint, vocal print, and human face recognition) to upload the obtained data to the cloud server for approving the payment, and software of which is mainly responsible for the password logon procedure and advertisement playing system of the customer-facing touch screen. The front end is powered by the Android system, hardware of which is configured for managing and connecting all operating devices (e.g., the cashier-facing touch screen, ticket dispenser, labeling machine, food-ordering machine, etc.), and the software of which is mainly responsible for interfacing with all applications (e.g., delivery & pick-up APP, ordering APP, membership APP, supplier APP) and cloud services (e.g., accounting service and financial service). The client/consumer may complete the payment only with a device having functions such as NFC and payment code. In the cloud-based biometric payment and retail management system of this embodiment, the front end is powered by an Android operating system and the back end is powered by a Linux operating system. First, the dual-OS configuration may enhance security. The cloud-based operation may guarantee that customer profiles will not be stored in the POS without presence of an authorized person; use of dual systems enables absolute independence of the data; the biometric database may use self-developed or updated computer language to prevent hackers without affecting operation of the POS terminal device 100. Second, the POS terminal device 100 service and the biometric database may be split into two companies which are developed and managed separately. The dual-OS configuration enhances compatibility. Third, the dual-OS configuration may win trust and approval from different institutions or even the government; besides, an ad playing function is built-in for financial companies, which works 24 hours per day; even the vendor switches off the POS terminal device 100, the ad display will still work, thereby enhancing the advertising effect. The management system according to this embodiment may be integrated with a new-generation ID card to serve as a cornerstone for future Smart City. The cloud-based biometric payment and retail management system according to this embodiment may serve as a proprietary biometric collection means and approval tools for the financial institution.

Specifically, when performing product/service transaction with the cloud biometric recognition and retail management system, the POS terminal device 100 obtains the product/service information from the cloud ERP server 200; after receiving the transaction information from the POS terminal device 100, password information inputted by the password input device, and biometric information acquired by the biometric acquisition and verification device, the cloud payment gateway server 300 checks the biometric information with the biometric database, and in the case of consistency, transmits the transaction information and the password information to the server corresponding to the financial institution for approval, such that if the approval passes, the server corresponding to the financial institution performs the payment transaction and generates transaction data; and the cloud payment gateway server 300 obtains the approval result of the financial institution and the transaction data, and feeds back them to the front end of the POS terminal device 100.

Specifically, the transaction information includes information about a target product/target service selected from the product/service information.

It needs to be noted that the ERP (Enterprise Resource Planning) is a management platform built on information technologies, which integrates the information technologies and the advanced management concepts so as to provide decision means for the employees and the decision-makers of an enterprise with the systematic management idea.

To facilitate exploitation of the cloud-based biometric recognition and retail management system, in this embodiment, the POS terminal device further comprises an electric money box and a power supply module supplying power to the front end and the back end; the Android operating system is configured with a network interface, a RAM, a storage space, a control interface, and a microprocessor; the other peripheral devices will be discussed infra. The Linux operating system is also configured with a network interface, a RAM, a storage space, a control interface, and a microprocessor; the other peripheral devices will be discussed infra. The front end includes a customer end and a vendor end; the back end is connected to an SVF (Hong Kong Stored Value Facility License) holder, financial institution, and biometric database.

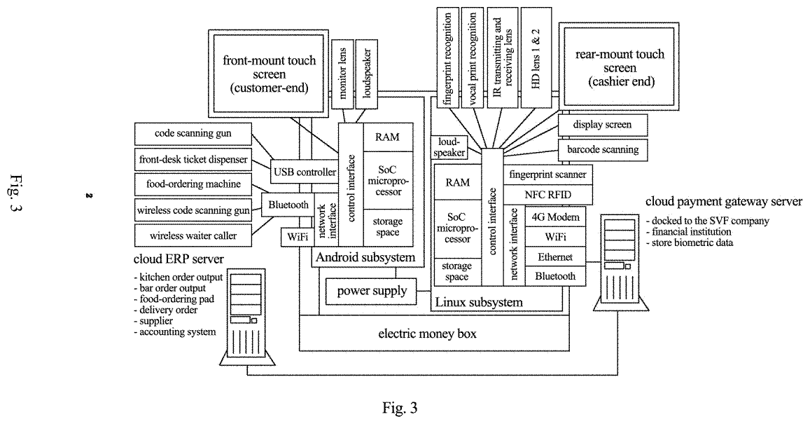

As shown in FIG. 3, the front end may be connected with the cloud ERP server 200 via any one or more of the 4G/LTE modem, Wi-Fi, Bluetooth or Ethernet. For example, it may be connected with the cloud ERP server 200 via Wi-Fi. The customer end of the POS terminal device is connected, via a USB controller, with any one or more of a two-dimensional code/three-dimensional code scanner (scanning gun), a front-end ticket dispenser, a front-end printer, a labeling machine, a handwriting input panel, or an external RAM. It may be understood that the customer end of the POS terminal device 100 may also be connected, via Bluetooth, with a food-ordering machine, a wireless two-dimensional code/three-dimensional code scanner (wireless code scanning gun), and a wireless waiter caller.

It may be understood that when the cloud ERP server 200 is connected to the POS terminal device 100, it may form any one or more of a kitchen & beverage bar order output system, food-ordering & reserving system, queuing & appointment system, membership & customer service system, delivery & pick-up system, accounting and inventory system, a download use system supplying a plurality of models of POS terminals, an online use system supplying a plurality of models of POS terminals, an advertisement and notification management system, an internal chat network and staff management system, an IoT & energy management system, a logistic management system, a supply chain management system, a CCTV & security system, or a store management system. Specifically, the CCTV and security system refers to the closed circuit TV security monitoring system.

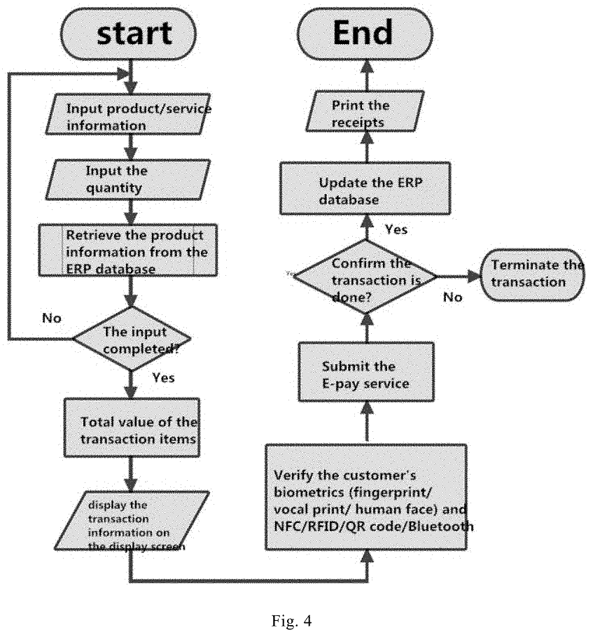

Please refer to FIG. 4, when transaction is made with any one of the above systems, it may be implemented by adopting the following execution process:

1) the customer inputs product/service information and quantity on the POS terminal device; the POS terminal device 100 obtains the product/service information from the cloud ERP server 200; then, the total payment of the transaction items is calculated, and the transaction information is displayed on the POS terminal device 100;

2) the vendor issues the receipts on the POS terminal device 100 and transmits a payment/transfer request to the cloud payment gateway server 300;

3) after receiving the request, the cloud payment gateway server 300 issues an instruction to request the customer to input e-wallet information and biometric information (finger print/palm print/vocal print/human face);

4) the customer inputs the e-wallet information and biometric information on the POS terminal device 100 and submits them to the electronic payment service;

5) the cloud payment gateway server 300, after receiving the e-wallet information and the biometric information, submits them to the biometric database for verification and then submits them to the server of the financial institution for approval;

6) after the approval, the cloud payment gateway server 300 will issue a notification to the vendor and the customer, and the cloud ERP server 200 prints receipts;

7) the server of the financial institution transfers money to the vendor, and then the transaction is completed.

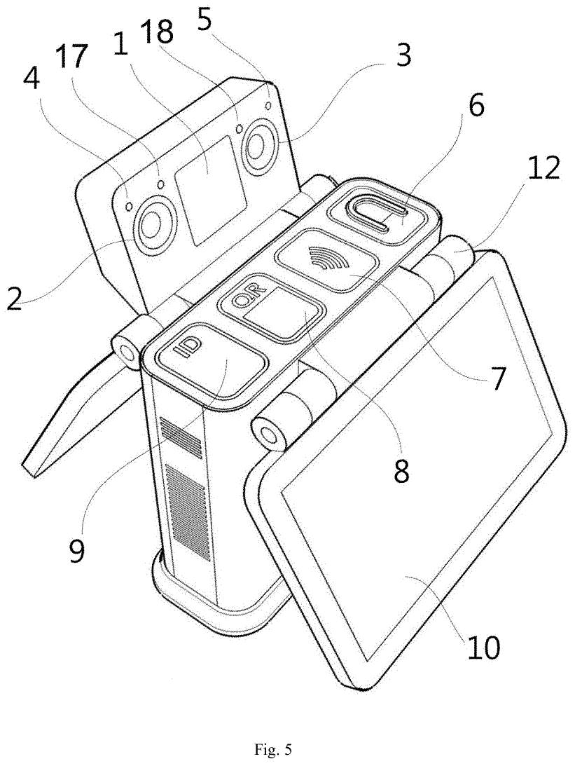

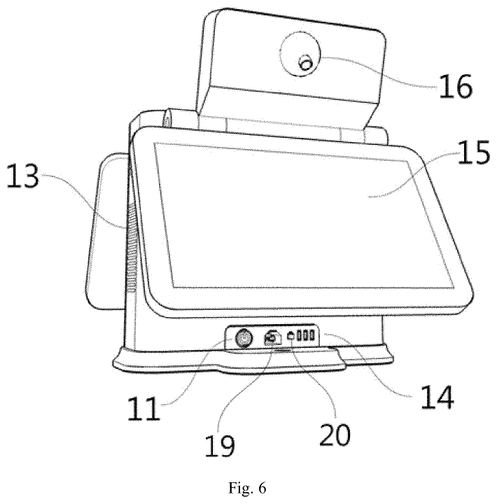

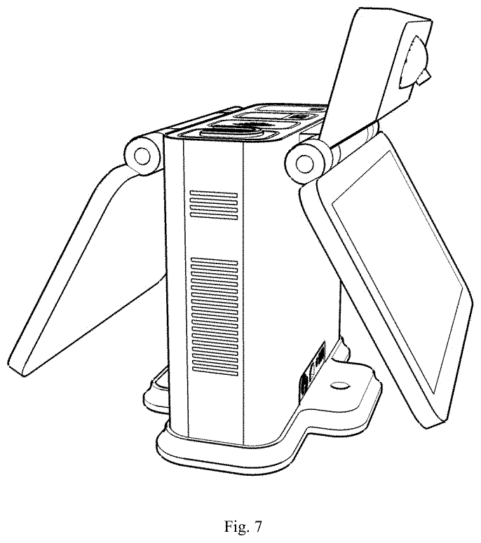

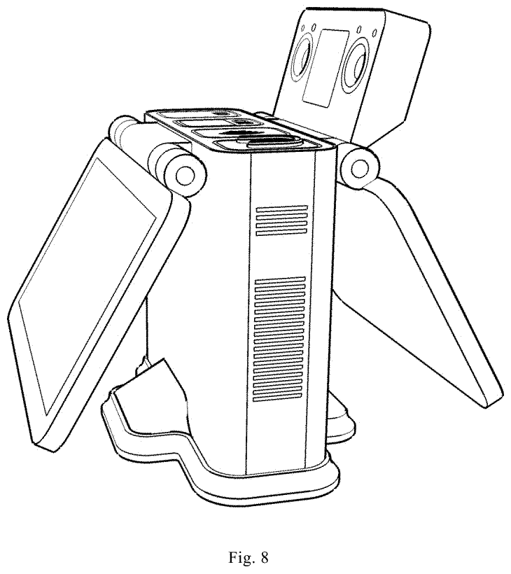

As shown in FIGS. 5, 6, 7, and 8, the POS terminal device 100 comprises a body and a cashier-facing cashier-end contact display 15 and a movable high-definition monitor lens 16, wherein the cashier-end contact display 15 is fixed to the body via a movable hinge 12; a rotary member is provided on the movable hinge 12 at the rear-end side; the movable high-definition monitor lens 16 is mounted on the rotary member; the POS terminal device 100 further comprises a customer-facing human face recognition display 1, a human face recognition high-resolution video camera lens 2, a high-definition video camera lens 3 for human face recognition or palm print recognition use, a first vocal print recognition receiver 4, a second vocal print recognition receiver 5, a far infrared transmitter 17, a far infrared video camera lens 18, a fingerprint recognition scanner or a finger vein scanner 6, an NFC/Bluetooth sensor 7, a two-dimensional code/three-dimensional code scanner 8, an NFC/RFID sensor 9, and a customer-end contact display 10; wherein the customer-end contact display 10 is fixed to the body via the movable hinge 12; the human face recognition display 1, the human face recognition high-resolution video camera lens 2, the high-definition video camera lens 3 for human face recognition or palm print recognition use, the first vocal print recognition receiver 4, the second vocal print recognition receiver 5, the far infrared transmitter 17 and the far infrared video camera lens 18 are disposed on the rotary member; the fingerprint recognition scanner or finger vein scanner 6, the NFC/Bluetooth sensor 7, the two-dimensional code/three-dimensional code scanner 8, and the NFC/RFID sensor 9 are disposed at the top portion of the POS terminal device 100; the POS terminal device 100 further comprises a power switch 11, a built-in loudspeaker 13, an external USB plug 14, a power cord inlet port 19, and an Ethernet cable inlet port 20, wherein the power switch 11, the power cord inlet port 19, the Ethernet cable inlet port 20, and the external USB plug 14 are disposed at the bottom portion of the POS terminal device 100 or at a side proximal to the cashier-end contact display, which facilitates use; the built-in loudspeaker 13 is disposed at a side face of the POS terminal device 100.

Specifically, in this embodiment, the front-end control interface is connected to the customer-end contact display 10, the human face recognition high-resolution video camera lens 2, and the built-in loudspeaker 13, respectively. The back end is connected to the cloud payment gateway server 300 via any one or more of the 4G/LTE modem, Wi-Fi, Bluetooth, or Ethernet, so as to control working states of the customer-end contact display 10, the human face recognition high-resolution video camera lens 2, and the built-in loudspeaker 13.

The cloud payment gateway server 300 is connected to the server of the financial institution and the biometric database. The back-end control interface is electrically connected to the NFC/RFID sensor 9, the NFC/Bluetooth sensor 7, the fingerprint recognition scanner or finger vein scanner 6, the two-dimensional code/three-dimensional code scanner 8, the high-definition video camera lens 3 for human face recognition or palm print recognition use, the cashier-end contact display 15, the movable high-definition monitor lens 16, the high-definition video camera lens 3 for human face recognition or palm print recognition, the human face recognition display 1, the first vocal print recognition receiver 4, the second vocal print recognition receiver 5, and the built-in loudspeaker 13, respectively, so as to control their working states.

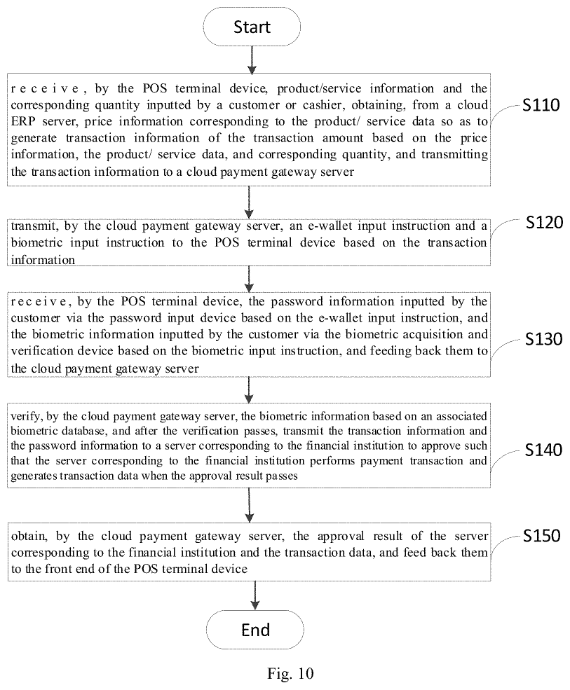

Referring to FIG. 10, which shows a payment method applicable to the cloud-based biometric payment and retail management system. The payment method comprises steps of:

Step S110: receiving, by a POS terminal device 100, product/service information and the corresponding quantity inputted by a customer or cashier, obtaining, from a cloud ERP server 200, price information corresponding to the product/service so as to generate transaction information including a transaction amount based on the price information, the product/service information, and corresponding quantity, and transmitting the transaction information to a cloud payment gateway server 300;

Step S120: transmitting, by the cloud payment gateway server 300, an e-wallet input instruction and a biometric input instruction to the POS terminal device 100 based on the transaction information;

Step S130: receiving, by the POS terminal device 100, the password information inputted by the customer via the password input device based on the e-wallet input instruction and the biometric information inputted by the customer via the biometric acquisition and verification device based on the biometric input instruction, and feeding back them to the cloud payment gateway server 300;

Step S140: checking, by the cloud payment gateway server 300, the biometric information with an associated biometric database, and after the verification passes, transmitting the transaction information and the password information to a server corresponding to the financial institution to approve such that if the approval result passes, the server corresponding to the financial institution performs payment transaction and generates transaction data; and

Step S150: obtaining, by the cloud payment gateway server 300, the approval result of the server corresponding to the financial institution and the transaction data, and feeding back them to the front end of the POS terminal device 100.

In this embodiment, before step S110, the method further comprises: obtaining, by the POS terminal device 100, the product/service information from the cloud ERP server 200.

Particularly, the varieties and quantities of the product/services obtained from the cloud ERP server 200 should be greater than or equal to the corresponding varieties and quantities of the product/services inputted by the customer or cashier.

After step S150, the method further comprises:

transmitting, by the POS terminal device 100, the transaction data to the cloud ERP server 200; and updating, by the cloud ERP server 200, the product/service information based on the transaction data. By updating the information in the cloud ERP server 200 in real time, the accuracy of the varieties and quantities of the product/services obtained from the cloud ERP server 200 during the subsequent transaction process is guaranteed, which further guarantees reliability of the transaction.

In the cloud-based biometric payment and retail management system according to this embodiment, the back end is provided with both of a password input device and a biometric acquisition and verification device, wherein the biometric acquisition and verification device is any one or more of the customer-facing human face recognition display 1, the human face recognition high-resolution video camera lens 2, the high-definition video camera lens 3 for human face recognition or palm print recognition use, the first vocal print recognition receiver 4, the second vocal print recognition receiver 5, the fingerprint recognition scanner or finger vein scanner 6, the far infrared transmitter 17, and the far infrared video camera lens 18, so as to use the biometric recognition technology as secondary verification for mobile electronic payment. It directly becomes a mobile payment means, i.e., biometric payment, even without a mobile product such as a mobile phone as a medium. The advantage is that the hacker can hardly steal and splice data from multiple channels. In specific circumstances, a traveler may perform electronic payment even without a mobile phone, a debit card, or a credit card. The secondary verification provides reliability and security for large-sum or very large-sum transactions. The biometric payment solution may prevent crimes and enhance case-solving efficiency.

Finally, it should be noted that the embodiments above are only used for illustrating the technical solution of the present disclosure, not to limit the protection scope of the present disclosure. although the present disclosure has been described in detail with reference to the preferred embodiments, those of normal skill in the art should understand that the technical solution of the present disclosure may be modified or equivalently substituted without departing from the essence and scope of the technical solution of the present disclosure.

I/We claim:

1. A cloud-based biometric payment and retail management system, comprising: a cashing service-enabled POS terminal device, a cloud-based ERP server, and a cloud payment gateway server; wherein the cloud ERP server is connected to the cloud payment gateway server, the POS terminal device comprises a front-end powered by an Android operating system and a back-end powered by a Linux operating system, the front end being connected with the cloud ERP server, the back end being connected to the cloud payment gateway server; and the back end is provided with a password input device and a biometric acquisition and verification device.

2. The cloud-based biometric payment and retail management system according to claim 1, wherein the cloud payment gateway server is associated with a server which corresponds to a financial institution and with a biometric database; after receiving the transaction information transmitted by the POS terminal device, password information inputted by the password input device, and biometric information acquired by the biometric acquisition and verification device, the cloud payment gateway server checks the biometric information with the biometric database, and in the case of consistency, transmits the transaction information and the password information to the server corresponding to the financial institution for approval, such that if the approval passes, the server corresponding to the financial institution performs the payment transaction and generates transaction data; and the cloud payment gateway server obtains the approval result of the financial institution and the transaction data, and feeds back them to the front end of the POS terminal device.

3. The cloud-based biometric payment and retail management system according to claim 2, wherein when receiving the approval result and transaction data fed back from the cloud payment gateway server, the POS terminal device transmits the transaction data to the cloud ERP server, and the latter updates the product/service information based on the transaction data.

4. The cloud-based biometric payment and retail management system according to claim 1, wherein the management system further comprises an electric money box and a power supply module which supplies power to the front end and the back end, wherein the electric money box and the power supply module are electrically connected to the POS terminal device, respectively.

5. The cloud-based biometric payment and retail management system, wherein the POS terminal device comprises a network interface, an RAM, a storage space, a control interface, and a microprocessor.

6. The cloud-based biometric payment and retail management system according to claim 1, wherein the front end is connected to the cloud ERP server via a 4G/LTE modem, Wi-Fi, Bluetooth, and/or Ethernet; and the cloud ERP server is connected to the vendor-end.

7. The cloud-based biometric payment and retail management system according to claim 1, wherein the POS terminal device is connected to a two-dimensional code/three-dimensional code scanner, a front-desk ticket dispenser, a front-desk printer, a labeling machine, a handwriting input panel, and/or an external RAM via a USB controller; and the POS terminal device is connected to a food ordering machine, a wireless two-dimensional code/three-dimensional code scanner, and/or a wireless waiter caller via Bluetooth.

8. The cloud-based biometric payment and retail management system according to claim 1, wherein the back end is connected to the cloud payment server via 4G/LTE modem, Wi-Fi, Bluetooth, and/or Ethernet.

9. The cloud-based biometric payment and retail management system according to any one of claims 1 to 8, wherein the POS terminal device comprises a body and a cashier-facing cashier-end contact display, wherein the cashier-end contact display is fixed to the body via a hinge.

10. The cloud-based biometric payment and retail management system according to claim 9, wherein the POS terminal device further comprises a high-definition monitor lens, the hinge is provided with a rotary member, and the high-definition monitor lens is mounted to the rotary member.

11. The cloud-based biometric payment and retail management system according to claim 10, wherein the biometric acquisition and verification device comprises a customer-facing human face recognition display, a human face recognition high-resolution video camera lens, a high-definition video camera lens for human face recognition or palm print recognition use, a first vocal print recognition receiver, a second vocal print recognition receiver, a far infrared transmitter, a far infrared video camera lens, a fingerprint recognition scanner, and/or a finger vein scanner.

12. The cloud-based biometric payment and retail management system according to claim 11, wherein the POS terminal device further comprises a customer-facing customer-end contact display which is fixed to the body via a hinge; the human face recognition display, the human face recognition high-resolution video camera lens, the high-definition video camera lens for human face recognition or palm print recognition use, the far infrared transmitter, the far infrared video camera lens, the first vocal print recognition receiver, and the second vocal print recognition receiver are provided to the body via the rotary member; and the fingerprint recognition scanner and/or the finger vein scanner are disposed at the top portion of the POS terminal device.

13. The cloud-based biometric payment and retail management system according to claim 12, wherein the POS terminal device further comprises a power switch, a power cord inlet port, an Ethernet cable inlet port, a built-in loudspeaker, and an external USB plug, wherein the built-in loudspeaker is disposed at a side face of the POS terminal device; and the power cord inlet port, the Ethernet cable inlet port, the power switch, and the external USB plug are disposed at the bottom portion of the POS terminal device.

14. The cloud-based biometric payment and retail management system according to claim 13, wherein the front-end control interface is connected to the customer-end contact display, the human face recognition high-resolution video camera lens, and the built-in loudspeaker, respectively, to control working states of the customer-end contact display, the human face recognition high-resolution video camera lens, and the built-in loudspeaker.

15. The cloud-based biometric payment and retail management system according to claim 14, wherein the back-end control interface is electrically connected to the NFC/RFID sensor, the NFC/Bluetooth sensor, the fingerprint recognition scanner or finger vein scanner, the two-dimensional code/three-dimensional code scanner, the high-definition video camera lens for human face recognition or palm print recognition use, the cashier-end contact display, the movable high-definition monitor lens, human face recognition display, the first vocal print recognition receiver, the second vocal print recognition receiver, and the built-in loudspeaker, respectively.

16. A payment method applied to the cloud-based biometric recognition and retail management system according to any one of claims 1-15, comprising:
receiving, by the POS terminal device, product/service information and the corresponding quantity inputted by a customer or cashier, obtaining, from a cloud ERP server, price information corresponding to the product/service so as to generate transaction information including a transaction amount based on the price information, the product/service information, and corresponding quantity, and transmitting the transaction information to a cloud payment gateway server;
transmitting, by the cloud payment gateway server, an e-wallet input instruction and a biometric input instruction to the POS terminal device based on the transaction information;
receiving, by the POS terminal device, the password information inputted by the customer via the password input device based on the e-wallet input instruction and the biometric information inputted by the customer via the biometric acquisition and verification device based on the biometric input instruction, and feeding back them to the cloud payment gateway server;
checking, by the cloud payment gateway server, the biometric information with an associated biometric database, and after the verification passes, transmitting the transaction information and the password information to a server corresponding to the financial institution to approve such that if the approval result passes, the server corresponding to the financial institution performs payment transaction and generates transaction data; and
obtaining, by the cloud payment gateway server, the approval result of the server corresponding to the financial institution and the transaction data, and feeding back them to the front end of the POS terminal device.

17. The payment method according to claim 16, wherein before the cloud payment gateway server obtains the approval result of the server corresponding to the financial institution and the transaction data and feeds back them to the front end of the POS terminal device, the method further comprises:
transmitting, by the POS terminal device, the transaction data to the cloud ERP server; and
updating, by the cloud ERP server, the product/service information based on the transaction data.

18. The payment method according to claim 16, wherein before the POS terminal device receives the product/service information and the corresponding quantity inputted by the customer or cashier, the method further comprises:
obtaining, by the POS terminal device, the product/service information from the cloud ERP server.
